(19) United States
(12) Patent Application Publication
(10) Pub. No.: US 2005/0204604 A1
(43) Pub. Date: Sep. 22, 2005

(54) Animated decoy apparatus

(76) Inventors: William L. Noles, Bruceton, TN (US); Leonard M. Noles, Bruceton, TN (US)

Correspondence Address: SMITH, GAMBRELL & RUSSELL, LLP, 1230 PEACHTREE STREET, N.E., SUITE 3100, PROMENADE II, ATLANTA, GA, 30309-3592, US

(21) Appl. No.: 10/804,464

(22) Filed: Mar. 19, 2004

(51) Int. Cl. A01M 31/06

(52) U.S. Cl. 43/2; 43/3

(57) ABSTRACT

An animated decoy apparatus for attracting fowl includes an animal body and a head member connected with the animal body, with a base mount for supporting the animal body. A body actuator is connected between the base mount and the animal body, the body actuator moving the animal body in a substantially lateral direction. A head actuator is connected between the animal body and the head member to move the head member in a substantially vertical plane. The apparatus includes a controller connected to the body actuator and the head actuator, the controller controlling the concurrent operation of the body actuator and the head actuator. Finally, a power source is connected to the controller. The controller is able to concurrently manage both the head actuator and the body actuator, such that the animated decoy apparatus has a scavenging and feeding motion to attract other fowl.

### FIELD OF THE INVENTION

The present invention relates to a hunting decoy, and, more specifically, to an animal decoy having a controllable life-like motion.

### BACKGROUND OF THE INVENTION

The use of decoys to attract animals is well known in hunting fields, as is the use of decoys that move to attract prey. This is true for many different species of animals, including fowl. One common decoy design for fowl that has been used by outdoorsmen is to attach strings or cords to an otherwise stationary decoy to cause the decoys to move when the string is pulled. Other birds at a distance are more apt to notice the moving decoy than decoys that are motionless, and are therefore more likely to join the decoy within the firing range of the outdoorsman.

Another relatively simple motion decoy is the flag decoy. These decoys are simple fowl-shaped flags that are affixed to the top of a pole. The fowl-shaped flag is then waved, either by the user or by a breeze, to attract birds from a distance. However, as the birds approach the fowl-shaped flag, the flag and pole must be laid down since the motion does not provide the realism necessary to attract birds in close proximity to the outdoorsman.

A slightly more complicated motion decoy is the use of a wind sock to mimic a bird in flight. In particular, these decoys are wind socks that are shaped and decorated to look like fowl such as ducks or geese. An example of such a design is found in U.S. Pat. No. 4,611,421. The wind sock decoys are mounted on shafts that are placed in the ground. The tops of the shafts are decorated with heads that resemble the head of a duck or goose. As the wind fills the wind sock, the wind sock will spin on its shaft so that the decoy will be facing into the wind. In addition, the wind will cause the decoys to move or shimmy as to increase the visibility of the decoy to distant birds and attract such birds to a desired location. These decoys work well in breezy conditions, but they perform poorly in extreme conditions (i.e., calm weather or extremely windy conditions). The wind sock decoys also work best when deployed in a dry field. When used in water, the fabric socks droop in the water in calm conditions and may become wet, preventing them from rising in a light wind. Additionally, these decoys are not effective in inclement weather, since the rain, freezing rain, sleet, or snow on wind sock decoys can weigh the socks down, preventing and desired movement in the breeze.

Another decoy design similar to the wind sock is described in U.S. Pat. No. 5,862,619. This device features a decoy mounted on a post and having a set of free spinning arms that rotate when blown by the wind. One side of the wings are typically painted dark and the other white so that the spinning motion resembles the flapping wings of a duck or goose. This device works like the others mentioned above in that it attracts birds from afar with the motion of its spinning wings. However, most decoys of this nature only operate when a breeze or wind is present. Furthermore, these designs may continue to move when waterfowl approach, which provides an unnatural look. Specifically, the decoy will either continue to hover in place without ever setting or it will flap its wings continuously while sitting on the water. Such devices will therefore alert the fowl of the outdoorsmen rather than attract fowl to a designated location.

Another decoy design is described in U.S. Pat. No. 6,170,188. Like the decoys previously discussed, these decoys also have a set of spinning wings that are mounted on a shaft. However, the wings of this design are motor driven instead of being wind driven. Since the wings are motor driven, they are not dependant upon wind power. Otherwise, the drawbacks of the decoys described in this patent are the same as those previously discussed. One additional drawback to this system is that they decoys typically cost substantially more for the motors used thereby.

### SUMMARY OF THE INVENTION

The present invention is an animated decoy apparatus for attracting fowl. The application includes a fowl body and a head member connected with the fowl body, with a base mount supporting the fowl body. A body actuator is connected between the proximal end of the base mount and the fowl body, the body actuator moving the fowl body in a substantially vertical plane. A head actuator is connected between the fowl body and the head member, the head actuator moving the head member in a substantially horizontal plane. The apparatus includes a controller connected to the body actuator and the head actuator, the controller controlling the concurrent operation of the body actuator and the head actuator. Finally, a power source is connected to the controller. The controller is able to concurrently manage both the head actuator and the body actuator, such that the animated decoy apparatus has a scavenging and feeding motion to attract other fowl.

### BRIEF DESCRIPTION OF THE DRAWINGS

An animated decoy apparatus embodying the features of the present invention is depicted in the accompanying drawings, which form a portion of this disclosure, wherein:

FIG. 1 is sectional side view of the motion turkey decoy of the present invention;

FIG. 2 is a front elevational view of the motion turkey decoy of the present invention;

FIG. 3 is a top plan view of the motion turkey decoy of the present invention; and

FIG. 4 is a flow chart of the connections of the operation of the motion turkey decoy.

### DETAILED DESCRIPTION OF THE PREFERRED EMBODIMENT

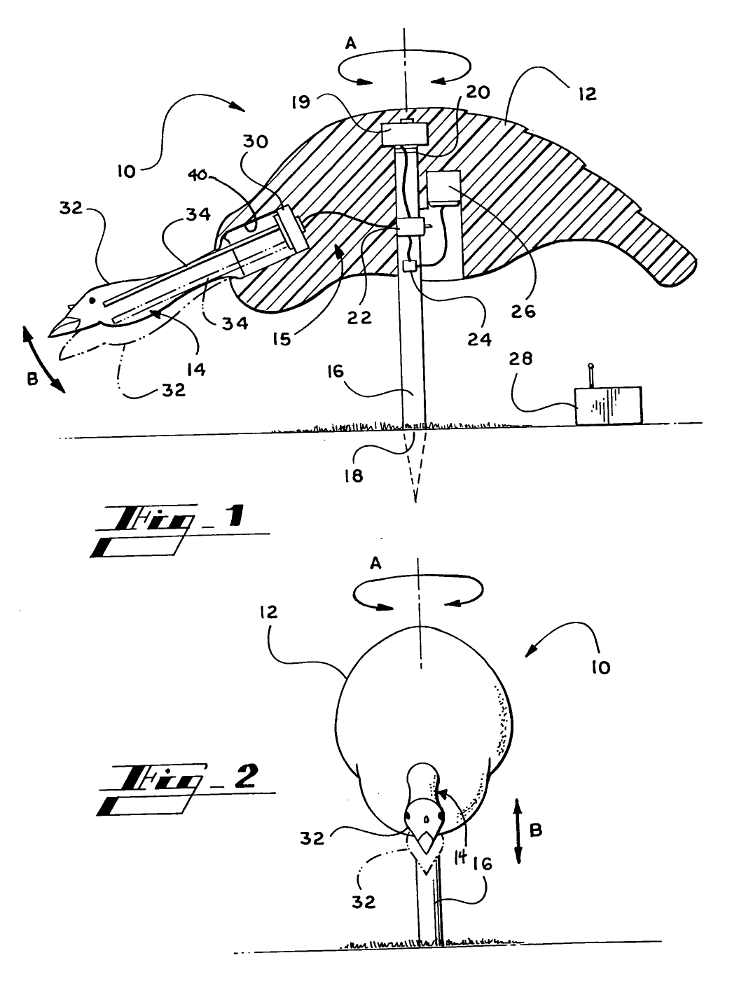

Looking now to FIG. 1, the present invention of an animated decoy apparatus 10 is illustrated. The animated decoy apparatus 10 includes an animal body or housing 12, such as a fowl-shaped housing, and a head member 14 connected to the animal body 12. A motion assembly 15 is connected with to the animal body 12, with the motion assembly 15 generating and controlling life-like movement of both the animal body 12 and the head member 14. Consequently, this natural motion of the animated decoy apparatus 10 increases the realistic appearance of the animated decoy apparatus 10 to thereby attract fowl to a location desired by the user.

More specifically, the animated decoy apparatus 10 includes a base mount 16 that supports the animal body 12. The base mount 16 includes a distal end 18 and a proximal end 20, with the distal end 18 being designed to securely support the animal body 12 with respect to a ground surface. In the embodiment illustrated in FIG. 1, the distal end 18 of the base mount 16 is in the form of a stake, such that it can easily be forced into the ground surface to support the animal body 12. However, it should be noted that the distal end 18 of the base mount 16 can be of a variety of other mounting designs, such as a heavy anchor, that will steadily support the animal body 12 above the ground surface.

The animal body 12 rests upon the proximal end 20 of the base mount 16. In one embodiment, a first or body actuator 19, such as a servomotor, is connected to the proximal end 20 of the base mount 16, with the animal body 12 being connected to the body actuator 19. The body actuator 19 will rotate or pivot the animal body 12 in a lateral direction, such as in a plane generally parallel to the ground surface, as shown as direction A in FIG. 3. This movement mimics a scanning or scavenging motion of an animal, such as a bird. Referring back to FIG. 1, the body actuator 19 is connected to a controller 22, which is additionally connected to a switch harness 24. The switch harness 24 is then connected to a power source 26, such as a series of batteries, which provides power to the body actuator 19. Thus, the switch harness 24 regulates the connection between the controller 22 and the body actuator 19. Therefore, the switch harness 24 controls when power may be supplied to the body actuator 19 from the power source 26, and therefore acts as the master controller. When the switch harness 24 provides a connection between the controller 22 and the body actuator 19, the controller 22 will then determine when the body actuator 19 is in operation.

Continuing to look at FIG. 1, the head member 14, or other anatomical appendage, extends from the animal body 12 through a head or neck slot 40, as discussed herein. The head member 14 includes a head covering 32 or shell surrounding a head rod 34. The head rod 34 is connected to a second or head actuator 30, such as a servomotor, with the head actuator 30 being supported by the base mount 16. The head actuator 30 actuates the head rod 34 in a direction indicated by line B in FIGS. 1 and 2. This motion mimics the actual feeding action of an animal, such as a goose or other bird. In addition, the head actuator 30 is connected to the controller 22. Thus, the controller 22 will direct the operation of the head actuator 30 in addition to the body actuator 19.

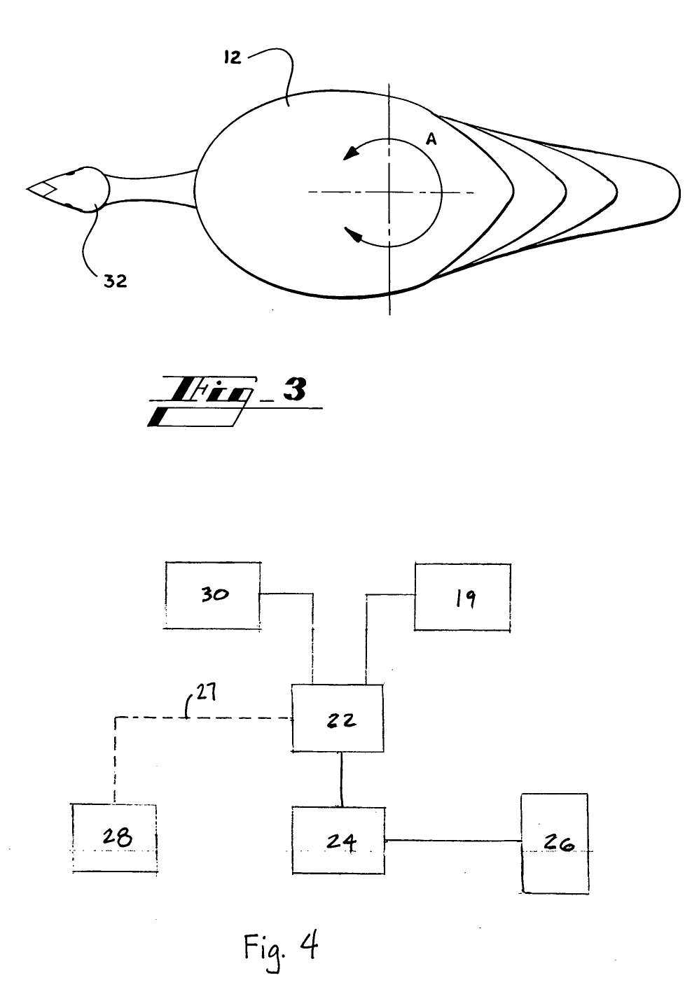

In one embodiment, the controller 22 is a remote control receiver which receives a signal from a transmitter 28, such as a remote control transmitter, as illustrated in FIGS. 1 and 4. The transmitter 28 is held by the operator and communicates an operational signal 27 to the controller 22 corresponding to the desired operation of the body actuator 19 or the head actuator 30. This therefore allows the operator to independently and concurrently control both the body actuator 19 and the head actuator 30 from a distance from the animated decoy apparatus 10. Thus, the user can manipulate the substantially horizontal motion of the animal body 12 while also controlling the substantially vertical motion of the head rod 34 simultaneously. Furthermore, since the operator is not in immediate proximity with the animal body 12, the operator will not scare any of the birds that are to be attracted to the location.

While one embodiment of the invention provides that the controller 22 is a remote control receiver that receives a wireless signal from the transmitter 28, it should also be noted that the present invention could provide a wired connection between the controller 22 and the transmitter 28. In such an embodiment, the user would simply hide or cover the cable (not illustrated) connecting the controller 22 with the transmitter 28, such that the user could remain hidden and maintain control over the desired operation of the body actuator 19 or the head actuator 30 of the animated decoy apparatus 10.

It is noteworthy that the body actuator 19 and the head actuator 30 are operable to work concomitantly to move the animal body 12 and the head member 14. That is, the body actuator 19 will move the animal body 12 in the scavenging direction A, while the head actuator 30 will concurrently move the head member 14 in the feeding direction B. Such movement provides a feeding motion of the animated decoy apparatus 10 accurately simulates the feeding movement of a live animal. That is, the animal body 12 of the animated decoy apparatus 10 will move side to side to simulate the search for food by a goose or a similar bird, while the head member 14 of the assembly will move up and down to simulate the actual feeding motion of a goose or similar bird.

The animal body 12 may be formed of a variety of elements. In the embodiment illustrated in FIG. 1, the animal body 12 is made of a hard-pressed or dense foam. In such a case, the animal body 12 will support the head actuator 30 and provide a channel to connect the head actuator 30 with the controller 22. That is, the head actuator 30 will most likely be mounted in the hard-pressed or dense foam in the forward chest area of the animated decoy apparatus 10. The foam could be “formed” to fit the very forward chest area of the animated decoy apparatus 10. A wire 31 will then be extended from the head actuator 30 to be connected with the power source 26 proximate the base mount 16.

The neck slot 40 traverses a portion of the animal body 12, extending from the edge of the animal body 12 to the head actuator 30. More particularly, the head rod 34 extends from the head actuator 30 outwardly through the neck slot 40 so as to be able to pivot or rotate as directed by the head actuator 30. In addition to this embodiment, it is to be noted that other embodiments of the animal body 12 may be incorporated into the present design. For example, the animal body 12 may be constructed of another suitable material, such as plastic or fiberglass, to provide a hollow shell that providing a housing for the motion assembly 15. Furthermore, the materials composing the animal body 12 will provide a water proof housing for the servomotors 19, 30 and power source 26, as well as the other actuating components.

As with the animal body 12, the head covering 32 of the head member 14 may be comprised of hard-pressed foam surrounding the head rod 34. In addition, the head covering 32 may be made of a plastic or rubber material that surrounds the head rod 34. In any case, it is important that the head member 14 provide a life-like appearance.

It should further be noted that the animated decoy apparatus 10 is designed to be easily transported by the outdoorsman. In particular, the base mount 16 is easily disconnected from the body actuator 19 and removable from the animated decoy apparatus 10. Such a design provides the user with the ability to transport the animated decoy apparatus 10 to the location for effective use in the attraction of birds.

Thus, although there have been described particular embodiments of the present invention of a new and useful ANIMATED DECOY APPARATUS, it is not intended that such references be construed as limitations upon the sprit and scope of this invention except as set forth in the following claims.

1. An animated decoy apparatus for attracting fowl comprising:
an animal body;
a head member connected with said animal body;
a base mount having a distal end and a proximal end, said proximal end supporting said animal body;
a body actuator connected between said proximal end of said base mount and said animal body, said body actuator moving said animal body in a first direction;
a head actuator connected between said animal body and said head member, said head actuator moving said head member in a second direction;
a controller connected to said body actuator and said head actuator, said controller controlling the concurrent operation of said body actuator and said head actuator; and
a power source connected to said controller, said power source providing power to said body actuator and said head actuator.

2. The animated decoy apparatus as described in claim 1, wherein said animal body comprises dense foam.

3. The animated decoy apparatus as described in claim 1, wherein said distal end of said base mount comprises a stake.

4. The animated decoy apparatus as described in claim 1, wherein said distal end of said base mount comprises an anchor.

5. The animated decoy apparatus as described in claim 1 further comprising a switch harness connected between said controller and said power source to govern when said power source is connected with said controller.

6. The animated decoy apparatus as described in claim 1, further comprising:
a transmitter;
wherein said controller is a remote control receiver; said remote control directing operation of said head actuator and said body actuator.

7. The animated decoy apparatus as described in claim 1, wherein said body actuator comprises a servomotor.

8. The animated decoy apparatus as described in claim 1, wherein said head actuator comprises a servomotor.

9. A method for attracting fowl to a desired location comprising the steps of:
a) providing an animal body pivotally supported on a base mount;
b) providing a head member pivotally connected to said animal body;
c) pivoting said animal body in a first direction using a body actuator connected between said animal body and said base mount; and
d) concurrently pivoting said head member in a second direction using a head actuator connected between to said animal body.

10. The method as described in claim 9, wherein step c) further comprises:
pivoting said animal body in said first direction in a substantially lateral direction.

11. The method as described in claim 9, wherein step d) further comprises:
pivoting said head member in said second direction that is substantially perpendicular to said first direction.

12. The method as described in claim 9, further comprising the step of:
controlling the operation of said body actuator and said head actuator with a central controller.

13. The method as described in claim 12, further comprising the step of:
operating said central controller with a remote control transmitter.

14. The method as described in claim 12, further comprising the step of:
providing power to said controller using a power source; and
directing the connection between said power source and said controller using a switch harness.

15. An animated decoy apparatus for attracting wildlife to a desired area, said animated decoy apparatus comprising:
an animal body;
an anatomical appendage pivotally connected to said animal body;
a base member supporting said animal body;
a first actuator connected to said base member and said animal body, said first actuator rotating said animal body in a first direction;
a second actuator connected to said animal body, said second actuator moving said anatomical appendage in a second direction; and
a power source connected to said first actuator and said second actuator.

16. The animated decoy apparatus as described in claim 15, further comprising a controller connected to said first actuator and said second actuator to direct operation of said first actuator and said second actuator, said controller regulating the concurrent motion of said animal body and said anatomical appendage.

17. The animated decoy apparatus as described in claim 16, wherein said controller is a remote control receiver, wherein said animated decoy apparatus further comprises a transmitter sending directions to said remote control receiver.

18. The animated decoy apparatus as described in claim 16 further comprising a switch harness connected between said controller and said power source to govern when said power source is connected with said controller.

19. The animated decoy apparatus as described in claim 17, wherein said animal body comprises dense foam.

20. The animated decoy apparatus as described in claim 15, wherein said base member includes a distal end and a proximal end, said distal end of said base member comprising a stake.

21. The animated decoy apparatus as described in claim 15, wherein said first direction is a generally lateral direction.

22. The animated decoy apparatus as described in claim 15, wherein said second direction is a generally vertical direction.
